(19) United States
(12) Patent Application Publication
(10) Pub. No.: US 2018/0071573 A1
(43) Pub. Date: Mar. 15, 2018

(54) Adjustable Supine Cycling Machine

(71) Applicants: Chong Kyu Kim, Fort Lee, NJ (US); Telesclaro S. Angel, Fort Lee, NJ (US)

(72) Inventors: Chong Kyu Kim, Fort Lee, NJ (US); Telesclaro S. Angel, Fort Lee, NJ (US)

(21) Appl. No.: 15/705,197

(22) Filed: Sep. 14, 2017

Related U.S. Application Data
(60) Provisional application No. 62/394,538, filed on Sep. 14, 2016.

(51) Int. Cl. A63B 22/06; A61H 1/02; A63B 22/00

(52) U.S. Cl. CPC A63B 22/0605; A61H 1/0214; A63B 2225/09; A63B 22/0694; A63B 22/0046

(57) ABSTRACT

An adjustable supine cycling machine is an apparatus that efficiently exercises and strengthens abdominal muscles. The apparatus targets the all of the abdominal muscles from all angles. As the user pedals, the user may retract or extend his or her legs and tilt his or her legs in order to activate all the muscles of the abdominal region. The apparatus includes a leg-exercising device, a support base, a lifting arm, and a linear actuator. A spherical bearing allows the tilt of the leg-exercising device. The leg-exercising device is preferably a cycling machine. The lifting arm pivots the leg-exercising device about the support base and is controlled by the linear actuator. The apparatus preferably applies resistance to the rotary movement of the leg-exercising device in order to strengthen the abdominal muscles. The resistance is adjusted by a control unit.

The current application claims a priority to the U.S. Provisional Patent application Ser. No. 62/394,538 filed on Sep. 14, 2016.

### FIELD OF THE INVENTION

The present invention relates generally to exercising machines. More specifically, the present invention is an adjustable supine cycling machine that targets all the muscles of the abdominal region while guiding the form of a user and strengthening the abdominal muscles with increased resistance.

### BACKGROUND OF THE INVENTION

Toning abdominal muscles and shedding fat from the midsection of a body is one of the most difficult physical goals of the average person. A lean midsection is not made from performing tens or hundreds of sit-ups, but rather good form and a healthy diet. Good form is typically monitored by a trainer or a workout partner. Hiring a trainer and working out with a partner, however, is not feasible for most people. Instead, a variety exercise machines are used in order to provide more guidance while performing abdominal exercises. These exercise machines are costly and require plenty of space.

The present invention ensures good form while performing abdominal exercise and requires both very little space and very little experience. A user simply lays down on his or her back and pedals. As the user pedals, the user may tilt his or her legs to the left and to the right, engaging more than one muscle in the midsection, specifically the obliques. The present invention also accommodates the desired angle of pedals above the ground such that the higher the pedals, the more the higher abdominal muscles are exercised. The lower the pedals, the more the lower abdominal muscles are exercised. The support of the pedals guides the form of the user as the user performs more repetitions. The present invention not only encourages good form but facilitates strength building by applying resistance to the rotation of the pedals.

### BRIEF DESCRIPTION OF THE DRAWINGS

FIG. 1 is a left side view of the present invention.

FIG. 2 is a right side view of the preferred embodiment of present invention.

FIG. 3 is a top side view of the preferred embodiment of the present invention.

FIG. 4 is a rear side view of the preferred embodiment of the present invention.

FIG. 5 is a perspective view of the length-adjustable adapter and the spherical bearing of the present invention.

FIG. 6 is a schematic view of the communication between the plurality of resistance-inducing magnets and the flywheel of the first pedal assembly and the flywheel of the second pedal assembly of the present invention.

FIG. 7 is a schematic view of the communication between the Hall-effect sensor and the tracking electromagnet of the present invention.

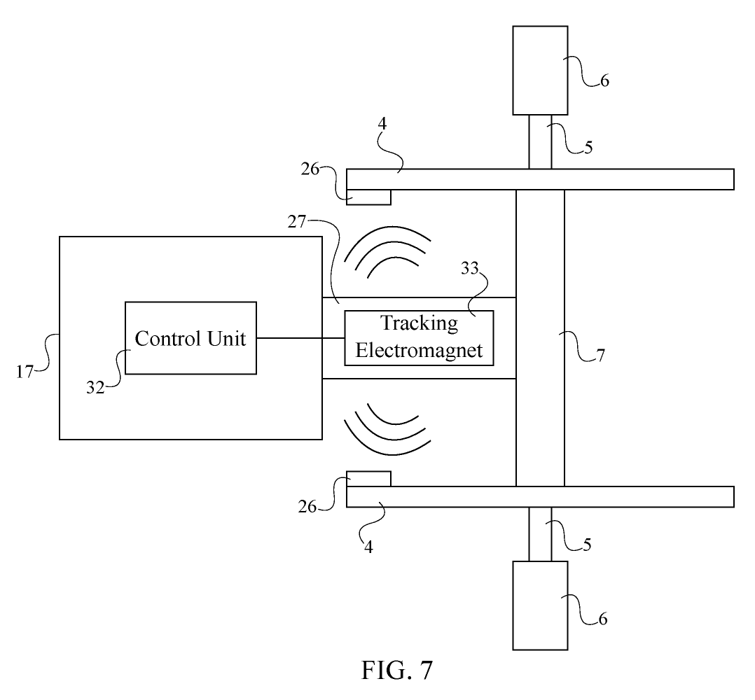

### DETAILED DESCRIPTION OF THE INVENTION

All illustrations of the drawings are for the purpose of describing selected versions of the present invention and are not intended to limit the scope of the present invention.

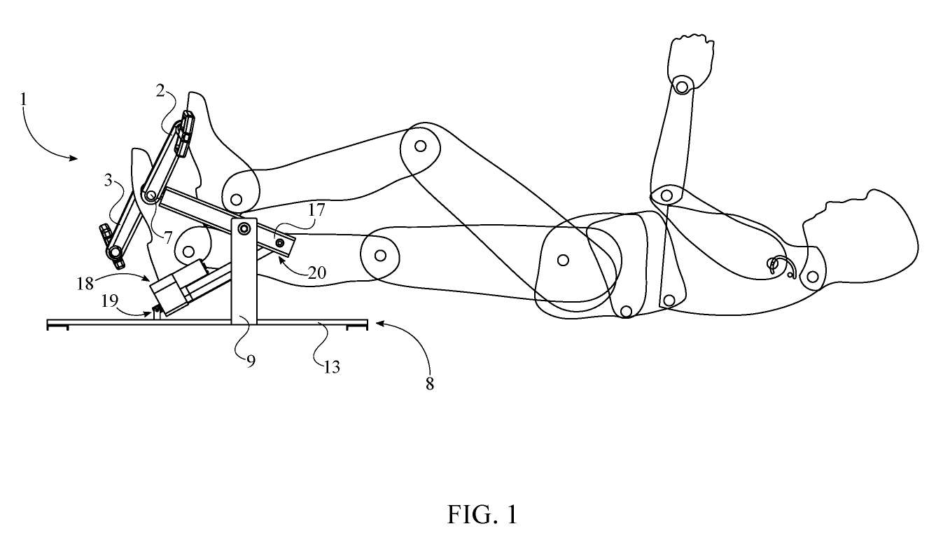

The present invention effectively exercises abdominal muscles. The present invention encourages proper form to efficiently exercise abdominal muscles. The present invention increases the strength of muscles by providing varying resistances. The present invention targets all abdominal muscle groups simultaneously. The present invention preferably engages the abdominal muscles of a user while in the supine position, as seen in FIG. 1. In order to engage abdominal muscles in this manner, the present invention comprises a leg-exercising device 1, a support base 8, a lifting arm 17, and a linear actuator 18. The leg-exercising device 1 guides and supports the motion of a user's legs while in a supine position. The leg-exercising device 1 is preferably a cycling machine. However, it is understood that the leg-exercising device 1 is not limited to a cycling machine and may be a variety of exercising machines that target the abdominal muscles. The support base 8 upholds the leg-exercising device 1 above the ground. The lifting arm 17 connects the leg-exercising device 1 to the support base 8. Moreover, the lifting arm 17 adjusts the angle of the leg-exercising device 1 with that of the support base 8, and consequently the height of the leg-exercising device 1 above the ground. The linear actuator 18 adjusts the angle and the height of the lifting arm 17. The linear actuator 18 holds the desired angle and height of the leg-exercising device 1 as well as move the leg-exercising device 1 forward and backwards. This forward and backward motion targets more abdominal muscles that are not utilized while simply pedaling. The user may decide to have a stationary leg-exercising device 1 or have a leg-exercising device 1 that moves linearly with respect to the lifting arm 17.

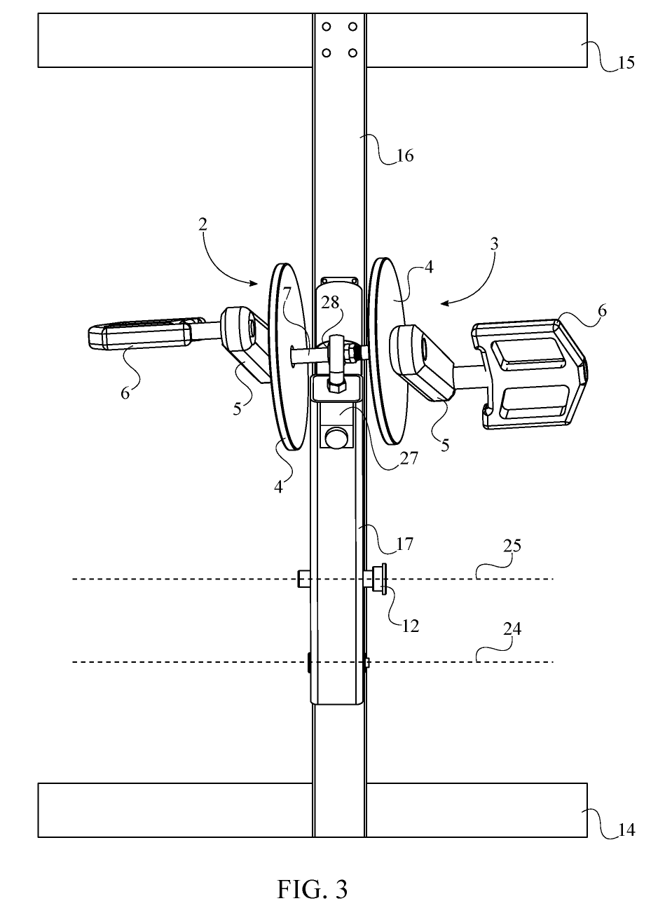

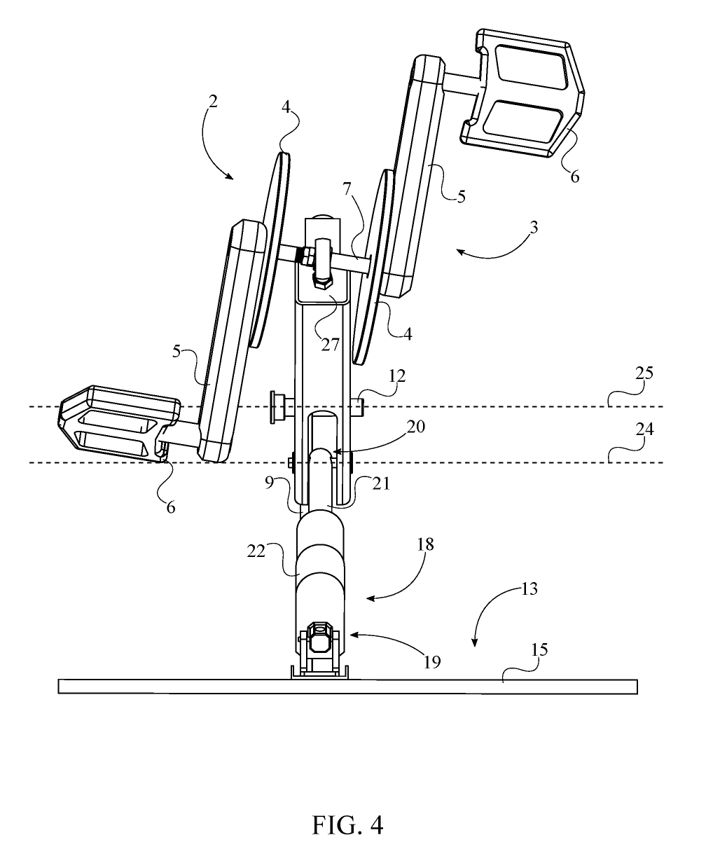

The overall configuration of the aforementioned components allows the height and length between the leg-exercising device 1 and the user to accommodate a variety of users. A fixed end 19 of the linear actuator 18 is rotatably connected to the support base 8 about a stationary axis 24, as shown in FIG. 3 and FIG. 4, preventing the user from sliding forward and backward while exercising with the leg-exercising device 1. The height of the leg-exercising device 1 is adjustable as a driving end 20 of the linear actuator 18 is rotatably connected to the lifting arm 17. The varying heights of the leg-exercising device 1 is supported by the lifting arm 17 which is rotatably mounted to the support base 8 about a fulcrum axis 25. The stationary axis 24 and the fulcrum axis 25 are positioned parallel and offset from each other in order for the linear actuator 18 to define the height between the leg-exercising device 1 and the ground. The leg-exercising device 1 is terminally attached to the lifting arm 17 and is positioned offset from the fulcrum axis 25 along the lifting arm 17, thereby maximizing the range of varying heights between leg-exercising device 1 and the ground.

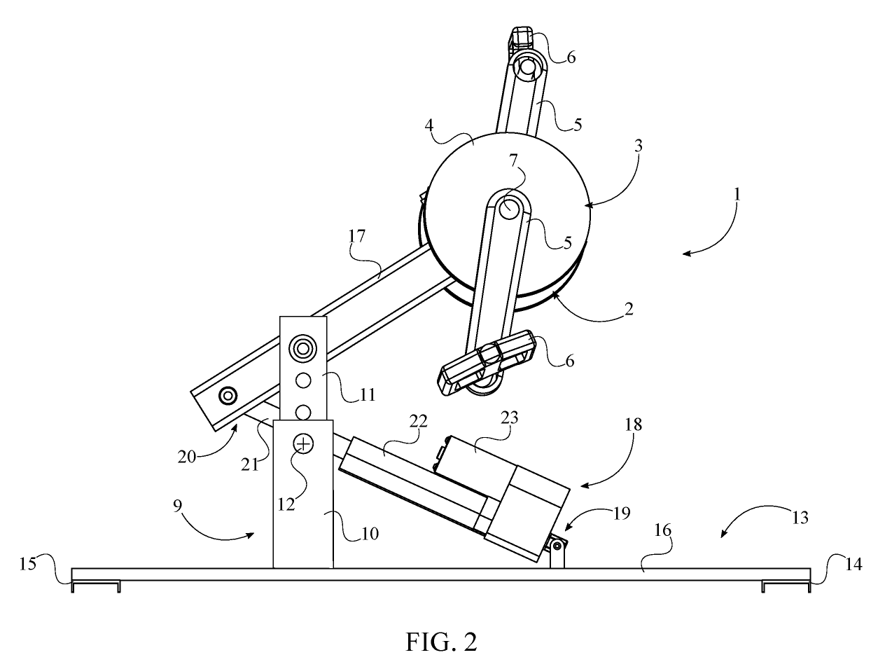

In order to support and mount the leg-exercising device 1 and the lifting arm 17 as the linear actuator 18 moves, the support base 8 comprises a height-adjustable stand 9 and a platform 13, as illustrated in FIG. 2. The height-adjustable stand 9 uplifts the leg-exercising device 1 above the stand and consequently the platform 13. The platform 13 mounts the present invention onto the ground and stabilizes the height-adjustable stand 9. The leg-exercising device 1 freely moves about the support base 8 and the user freely maneuvers the leg-exercising device 1 as the height adjustable stand is mounted onto the platform 13 and is oriented normal to the platform 13. The linear actuator 18 is rotatably connected to the platform 13 about the stationary axis 24, mounting the linear actuator 18 while the angle of the lifting arm 17 is adjusted. The lifting arm 17 is rotatably connected to the height-adjustable stand 9 about the fulcrum axis 25 and is positioned offset from the platform 13 along the height adjustable stand. This configuration allows the linear actuator 18 to angle the lifting arm 17 about fulcrum axis 25, consequently altering the height of the leg-exercising device 1 above the ground.

In the preferred embodiment of the present invention, the platform 13 comprises a first leg 14, a second leg 15, and a central beam 16, as shown in FIG. 2 and FIG. 3. The first leg 14 and the second leg 15 stabilize the leg-exercising device 1, the lifting arm 17, and the linear actuator 18. The central beam 16 mounts the linear actuator 18. The first leg 14 is terminally connected to the central beam 16, and the second leg 15 is terminally connected to the central beam 16, opposite the first leg 14. The first leg 14 and the second leg 15 are oriented perpendicular to the central beam 16. The configuration between the first leg 14 and the second leg 15 with that of the central beam 16 maximizes the stability of the adjustable support with the platform 13. The adjustable support stand is connected adjacent the central beam 16, effectively supporting the lifting arm 17.

Furthermore, the height-adjustable stand 9 preferably comprises a main sleeve 10, an extension post 11, and a pin-locking mechanism 12, as seen in FIG. 3. The main sleeve 10 houses and orients the extension post 11. The extension post 11 connects the lifting arm 17 to the platform 13, as well as lengthens and shrinks the height of the height-adjustable stand 9. The pin-locking mechanism 12 secures a desired height of the height-adjustable stand 9. The main sleeve 10 is terminally connected onto the platform 13, upholding the extension post 11 above the platform 13. The extension post 11 is telescopically connected into the main sleeve 10, opposite to the platform 13 in order for the height of the height-adjustable stand 9 to extend and retract. The position of the extension post 11 within the main sleeve 10 is fixed with the pin-locking mechanism 12 as the pin-locking mechanism 12 is mechanically integrated into the telescopic connection between the extension post 11 and the main sleeve 10.

In order for the lifting arm 17 to rotate about the fulcrum axis 25, the linear actuator 18 comprises a driving shaft 21, a tubular housing 22, and an electric motor 23, as seen in FIG. 2 and FIG. 4. The driving shaft 21 pushes and pulls the lifting arm 17 away from and towards the support base 8. The tubular housing 22 houses the driving shaft 21. Moreover, the tubular housing 22 contains and conceals the electrical connections and mechanical connections that maneuver the driving shaft 21. The configuration of the aforementioned components of the linear actuator 18 is such that the driving shaft 21 is slidably engaged into the tubular housing 22. The tubular housing 22 is rotatably connected to the platform 13, opposite the driving shaft 21, in order for the linear movement of the driving shaft 21 to push and pull the lifting arm 17. The height of the leg-exercising device 1 varies as the driving shaft 21 is rotatably connected to the lifting arm 17, opposite to the tubular housing 22. The electric motor 23 controls the linear movement of the driving shaft 21 into and out of the tubular housing 22, and consequently the height of the leg-exercising device 1. The electric motor 23 is externally mounted onto the tubular housing 22. The electric motor 23 is operatively coupled to the driving shaft 21, wherein the electric motor 23 is used to extend and retract the driving shaft 21 from the tubular housing 22.

In the preferred embodiment of the present invention, not only is the height of the leg-exercising device 1 adjustable with respect to the ground, but so is the distance between the support base 8 and the user. In the event that the support base 8 is fixed to the ground and a padded seat or padded bed that is used in conjunction with the present invention is also mounted to the ground, the leg-exercising device 1 may be positioned closer to the user with the length-adjustable adapter 27. The leg-exercising device 1 is terminally attached to the lifting arm 17 by the length-adjustable adapter 27, as seen in FIG. 3, further distancing from or retracting the leg-exercising device 1 to the support base 8. The length-adjustable adapter 27 is preferably telescopically engaged with the lifting arm 17 and is secured to the lifting arm 17 with a pin or bolt.

In order to effectively target the abdominal muscles, the leg-exercising device 1 comprises a first pedal assembly 2, a second pedal 6 assembly 3, and a shared axle 7, illustrated in FIG. 3 and FIG. 4. The first pedal assembly 2 and the second pedal 6 assembly 3 support the feet of the user and guide the rotating motion of the feet. The shared axle 7 secures and aligns the first pedal assembly 2 and the second pedal 6 assembly 3 about the lifting arm 17. The first pedal assembly 2 and the second pedal 6 assembly 3 are torsionally mounted to the shared axle 7 and positioned opposite to each other along the shared axle 7. This configuration correctly orients and positions the legs and feet of the user about the present invention. The feet and legs of the user may tilt about the lifting arm 17, while pedaling as the shared axle 7 is precessionally mounted to the lifting arm 17. This tilt targets the oblique muscles of the user and varies the movement of the abdominal muscles, continuously challenging the abdominal muscles.

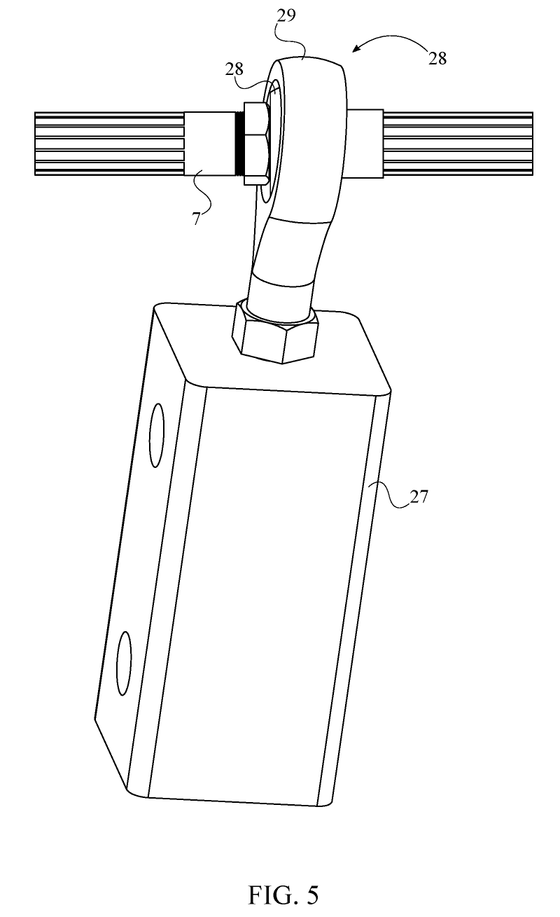

In order for the shared axle 7 to be precessionally mounted to the lifting arm 17, the preferred embodiment of the present invention comprises a spherical bearing 28, shown in FIG. 3, FIG. 4, FIG. 5. The lifting arm 17 is peripherally connected to an outer race 29 of the spherical bearing 28. The inner race 30 of the spherical bearing 28 is integrated along the shared axle 7. This configuration allows first pedal assembly 2 and the second pedal 6 assembly 3 tilt while being secured to the lifting arm 17.

In order for the user to maneuver the first pedal assembly 2 and the second pedal 6 assembly 3, the first pedal assembly 2 and the second pedal 6 assembly 3 each comprise a flywheel 4, a crank arm 5, and a pedal 6, shown in FIG. 3 and FIG. 4. The flywheel 4 provides a smoother pedaling. The crank allows the pedal 6 to rotate about shared axle 7, thereby allowing the user to pedal 6. The pedal 6 supports and positions the foot of the user on the present invention. The crank arm 5 is terminally and torsionally connected to the shared axle 7. The pedal 6 is rotatably connected to the crank arm 5, opposite the shared axle 7 so that the foot and leg of user does not inhibit the rotary movement of crank arm 5 and the pedal 6. The flywheel 4 is torsionally and laterally connected to the shared axle 7, adjacent to the crank arm 5.

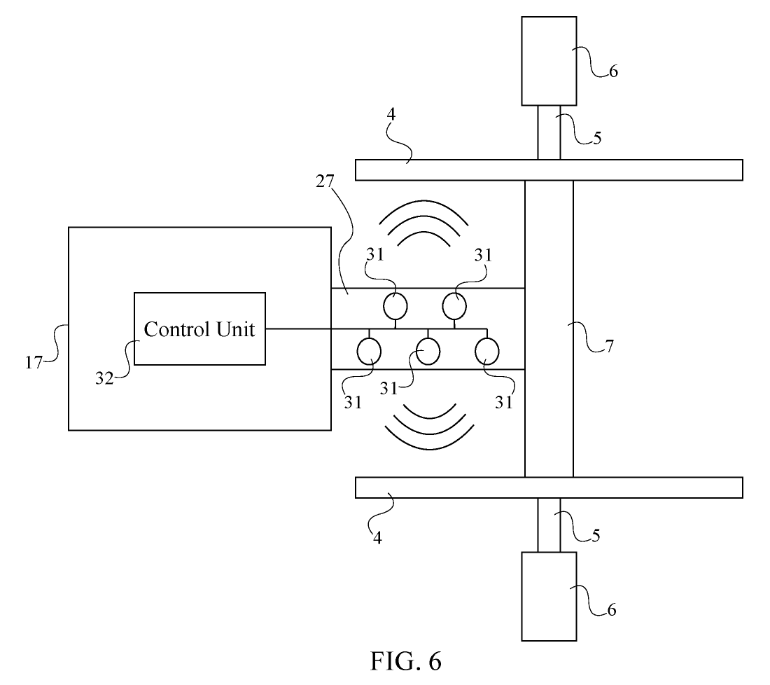

The preferred embodiment of the present invention applies resistance to the rotary movement of the first pedal assembly 2 and the second pedal assembly 3. The resistance increases the stress of the abdominal muscles as the user pedals. In order to apply resistance, the present invention further comprises a plurality of resistance-inducing electromagnets 31 and a control unit 32, seen in the schematic view of FIG. 6. Furthermore, the flywheel 4 is preferably made of metallic material. The plurality of resistance-inducing electromagnets 31 provide resistance to the rotation of the flywheel 4 of the first pedal assembly 2 and the second pedal 6 assembly 3 via a magnetic field. The plurality of resistance-inducing electromagnets 31 stimulates a counter rotation through a polarity change, thereby generating higher resistance to the rotatory motion of the first pedal assembly 2 and the second pedal assembly 3. Each of the plurality of resistance-inducing electromagnets 31 are preferably arranged in an arc-like configuration to accommodate the rotation of the flywheel 4 of the first pedal assembly 2 and the flywheel 4 of the second pedal 6 assembly 3. The control unit 32 allows the user to adjust the strength of resistance induced by the plurality of resistance-inducing electromagnets 31. The control unit 32 is connected to a power source that may be positioned external to the present invention or is integrated into the present invention. The control unit 32 distributes the power to any electrical component integrated within the present invention. In order for the flywheel 4 of the first pedal assembly 2 and the flywheel 4 of the second pedal 6 assembly 3 to be affected by the plurality of resistance-inducing electromagnets 31, the plurality of resistance-inducing electromagnets 31 is integrated into the length-adjustable adapter 27. More specifically, the plurality of resistance-inducing electromagnets 31 is magnetically coupled to the flywheel 4 of the first pedal assembly 2 and the flywheel 4 of the second pedal assembly 3 such that the faster the user pedals, the more resistance applied to the rotary motion of the flywheel 4 of the first pedal assembly 2 and the flywheel 4 of the second pedal assembly 3. The control unit 32 is electronically connected to the plurality of resistance-inducing electromagnets 31 so that a current may be driven through the plurality of resistance-inducing electromagnets 31. This current allows the user to adjust the resistance generated by the magnetic field of the plurality of resistance-inducing electromagnets 31.

In an alternate embodiment of the present invention, data of performance of the user through the first pedal assembly 2 and the second pedal assembly 3 is documented and analyzed. This alternate embodiment further comprises a Hall-effect sensor 26 and a tracking electromagnet 33, seen in the schematic view of FIG. 6. The tracking electromagnet 33 provides resistance to the rotation of the flywheel 4 of the first pedal assembly 2 and the second pedal assembly 3 via a magnetic field. The Hall-effect sensor 26 detects and reads the magnetic field the magnetic fields generated between the tracking electromagnet 33 and both the flywheel 4 of the first pedal assembly 2 and the flywheel 4 of the second pedal 6 assembly 3. The Hall-effect sensor 26 delivers data to the control unit 32 which adjusts the current delivered to the plurality of resistance-inducing electromagnets 31. In order to detect the magnetic field, the Hall-effect sensor 26 is integrated into the length-adjustable adapter 27. The tracking electromagnet 33 is peripherally mounted onto the flywheel and is in periodic magnetic communication with the Hall-effect sensor 26. This configuration allows the Hall-effect sensor 26 to detect and collect data regarding the performance of the user with the present invention. In order to control the strength of resistance, the tracking electromagnet 33 is electronically connected to the control unit 32. A variety of sensors may be integrated into the lifting arm 17 and may be electronically connected to the control unit 32 in order to provide more data regarding the performance of the user. The present invention may further comprise an actuator vibration sensor that detects the frequency of rotation, thereby allowing a user to more accurately monitor his or her physical progress.

In another embodiment of the present invention, regression analysis may be performed on the data collected of the performance. This data is stored on a database and is accessed through a portable computing device. A wireless communication device is integrated into lifting arm 17 and is electrically coupled to the control unit 32.

Although the invention has been explained in relation to its preferred embodiment, it is to be understood that many other possible modifications and variations can be made without departing from the spirit and scope of the invention as hereinafter claimed.

What is claimed is:

1. An adjustable supine cycling machine comprises:
a leg-exercising device;
a support base;
a lifting arm;
a linear actuator;
a fixed end of the linear actuator being rotatably connected to the support base about a stationary axis;
a driving end of the linear actuator being rotatably connected to the lifting arm;
the lifting arm being rotatably mounted to the support base about a fulcrum axis;
the stationary axis and the fulcrum axis being positioned parallel and offset from each other; and,
the leg-exercising device being terminally attached to the lifting arm;
the leg-exercising device being positioned offset from the fulcrum axis along the lifting arm.

2. The adjustable supine cycling machine as claimed in claim 1 comprises:
the support base comprises a height-adjustable stand and a platform;
the height-adjustable stand being mounted onto the platform;
the height-adjustable support stand being oriented normal to the platform;
the linear actuator being rotatably connected to the platform about the stationary axis;
the lifting arm being rotatably connected to the height-adjustable stand about the fulcrum axis; and,
the lifting arm being positioned offset from the platform along the height-adjustable stand.

3. The adjustable supine cycling machine as claimed in claim 2 comprises:
the platform comprises a first leg, a second leg, and a central beam;
the first leg being terminally connected to the central beam;
the second leg being terminally connected to the central beam, opposite the first leg;
the first leg and the second leg being oriented perpendicular to the central beam; and,
the adjustable support stand being connected adjacent the central beam.

4. The adjustable supine cycling machine as claimed in claim 2 comprises:
the height-adjustable stand comprises a main sleeve, an extension post, and a pin-locking mechanism;
the main sleeve being terminally connected onto the platform;
the extension post being telescopically connected into the main sleeve, opposite to the platform; and,
the pin-locking mechanism being mechanically integrated into the telescopic connection between the extension post and the main sleeve.

5. The adjustable supine cycling machine as claimed in claim 1 comprises:
the linear actuator comprises a driving shaft, a tubular housing, and an electric motor;
the driving shaft being slidably engaged into the tubular housing;
the tubular housing being rotatably connected to the platform, opposite the driving shaft;
the driving shaft being rotatably connected to the lifting arm, opposite to the tubular housing;
the electric motor being externally mounted onto the tubular housing; and,
the electric motor being operatively coupled to the driving shaft, wherein the electric motor is used to extend and retract the driving shaft from the tubular housing.

6. The adjustable supine cycling machine as claimed in claim 1 comprises:
a length-adjustable adapter; and,
the leg-exercising device being terminally attached to the lifting arm by the length-adjustable adapter.

7. The adjustable supine cycling machine as claimed in claim 1 comprises:
the leg-exercising device comprises a first pedal assembly, a second pedal assembly, and a shared axle;
the first pedal assembly and the second pedal assembly being torsionally mounted to the shared axle;
the first pedal assembly and the second pedal assembly being positioned opposite to each other along the shared axle; and,
the shared axle being precessionally mounted to the lifting arm.

8. The adjustable supine cycling machine as claimed in claim 7 comprises:
a spherical bearing;
the lifting arm being peripherally connected to an outer race of the spherical bearing; and,
an inner race of the spherical bearing being integrated along the shared axle.

9. The adjustable supine cycling machine as claimed in claim 7 comprises:
the first pedal assembly and the second pedal assembly each comprise a flywheel, a crank arm, and a pedal;
the crank arm being terminally and torsionally connected to the shared axle;
the pedal being rotatably connected to the crank arm, opposite the shared axle; and,
the flywheel being torsionally and laterally connected to the shared axle, adjacent to the crank arm.

10. The adjustable supine cycling machine as claimed in claim 9 comprises:
a length-adjustable adapter;
a plurality of resistance-inducing electromagnets;
a control unit;
the flywheel being made of a metallic material;
the leg-exercising device being terminally attached to the lifting arm by the length-adjustable adapter;
the plurality of resistance-inducing electromagnets being integrated into the length-adjustable adapter;
the plurality of resistance-inducing electromagnets being magnetically coupled to the flywheel of the first pedal assembly and the flywheel of the second pedal assembly; and,
the control unit being electronically connected to the plurality of resistance inducing electromagnets.

11. The adjustable supine cycling machine as claimed in claim 9 comprises:
a length-adjustable adapter;
a Hall-effect sensor;
a tracking electromagnet;
a control unit;
the leg-exercising device being terminally attached to the lifting arm by the length-adjustable adapter;
the Hall-effect sensor being integrated into the length-adjustable adapter;
the tracking electromagnet being peripherally mounted onto the flywheel;
the tracking electromagnet being in periodic magnetic communication with the Hall-effect sensor; and,
the tracking electromagnet being electronically connected to the control unit.

12. An adjustable supine cycling machine comprises:
a leg-exercising device;
a support base;
a lifting arm;
a linear actuator;
a length-adjustable adapter;
a fixed end of the linear actuator being rotatably connected to the support base about a stationary axis;
a driving end of the linear actuator being rotatably connected to the lifting arm;
the lifting arm being rotatably mounted to the support base about a fulcrum axis;
the stationary axis and the fulcrum axis being positioned parallel and offset from each other;
the leg-exercising device being terminally attached to the lifting arm;
the leg-exercising device being positioned offset from the fulcrum axis along the lifting arm; and,
the leg-exercising device being terminally attached to the lifting arm by the length-adjustable adapter.

13. The adjustable supine cycling machine as claimed in claim 12 comprises:
the support base comprises a height-adjustable stand and a platform;
the platform comprises a first leg, a second leg, and a central beam;
the height-adjustable stand being mounted onto the platform;
the height-adjustable support stand being oriented normal to the platform;
the linear actuator being rotatably connected to the platform about the stationary axis;
the lifting arm being rotatably connected to the height-adjustable stand about the fulcrum axis;
the lifting arm being positioned offset from the platform along the height-adjustable stand;
the first leg being terminally connected to the central beam;
the second leg being terminally connected to the central beam, opposite the first leg;
the first leg and the second leg being oriented perpendicular to the central beam; and,
the adjustable support stand being connected adjacent the central beam.

14. The adjustable supine cycling machine as claimed in claim 13 comprises:
the height-adjustable stand comprises a main sleeve, an extension post, and a pin-locking mechanism;
the main sleeve being terminally connected onto the platform;
the extension post being telescopically connected into the main sleeve, opposite to the platform; and,
the pin-locking mechanism being mechanically integrated into the telescopic connection between the extension post and the main sleeve.

15. The adjustable supine cycling machine as claimed in claim 12 comprises:
the linear actuator comprises a driving shaft, a tubular housing, and an electric motor;
the driving shaft being slidably engaged into the tubular housing;
the tubular housing being rotatably connected to the platform, opposite the driving shaft;
the driving shaft being rotatably connected to the lifting arm, opposite to the tubular housing;
the electric motor being externally mounted onto the tubular housing; and,
the electric motor being operatively coupled to the driving shaft, wherein the electric motor is used to extend and retract the driving shaft from the tubular housing.

16. The adjustable supine cycling machine as claimed in claim 12 comprises:
the leg-exercising device comprises a first pedal assembly, a second pedal assembly, and a shared axle;
a spherical bearing;
the first pedal assembly and the second pedal assembly being torsionally mounted to the shared axle;
the first pedal assembly and the second pedal assembly being positioned opposite to each other along the shared axle; and,
the shared axle being precessionally mounted to the lifting arm.
the lifting arm being peripherally connected to an outer race of the spherical bearing; and,
an inner race of the spherical bearing being integrated along the shared axle.

17. The adjustable supine cycling machine as claimed in claim 16 comprises:
the first pedal assembly and the second pedal assembly each comprise a flywheel, a crank arm, and a pedal;
the crank arm being terminally and torsionally connected to the shared axle;
the pedal being rotatably connected to the crank arm, opposite the shared axle; and,
the flywheel being torsionally and laterally connected to the shared axle, adjacent to the crank arm.

18. The adjustable supine cycling machine as claimed in claim 17 comprises:
a length-adjustable adapter;
a plurality of resistance-inducing electromagnets;
a control unit;
the flywheel being made of a metallic material;
the leg-exercising device being terminally attached to the lifting arm by the length-adjustable adapter;
the plurality of resistance-inducing electromagnets being integrated into the length-adjustable adapter;
the plurality of resistance-inducing electromagnets being magnetically coupled to the flywheel of the first pedal assembly and the flywheel of the second pedal assembly; and,
the control unit being electronically connected to the plurality of resistance inducing electromagnets.

19. The adjustable supine cycling machine as claimed in claim 17 comprises:
a length-adjustable adapter;
a Hall-effect sensor;
a tracking electromagnet;
a control unit;
the leg-exercising device being terminally attached to the lifting arm by the length-adjustable adapter;
the Hall-effect sensor being integrated into the length-adjustable adapter;
the tracking electromagnet being peripherally mounted onto the flywheel;
the tracking electromagnet being in periodic magnetic communication with the Hall-effect sensor; and,
the tracking electromagnet being electronically connected to the control unit.
